(19) United States
(12) Patent Application Publication
(10) Pub. No.: US 2010/0013924 A1
(43) Pub. Date: Jan. 21, 2010

(54) METHOD OF RETRIEVING IMAGE DATA OF A MOVING OBJECT, APPARATUS FOR PHOTOGRAPHING AND DETECTING A MOVING OBJECT, AND APPARATUS FOR RETRIEVING IMAGE DATA OF A MOVING OBJECT

(75) Inventors: Makoto HASEGAWA, Yokohama (JP); Toshihiro YAMANAKA, Yokohama (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/483,018

(22) Filed: Jun. 11, 2009

Related U.S. Application Data
(63) Continuation of application No. 10/953,054, filed on Sep. 29, 2004, now abandoned.

(30) Foreign Application Priority Data
Mar. 31, 2004 (JP) 2004-104723

(51) Int. Cl. H04N 7/18; G08B 21/00

(52) U.S. Cl. 348/143; 340/686.6; 348/E07.085

(57) ABSTRACT

The purpose of the present invention is to efficiently retrieve the image data of a specific moving object from the data of images photographed in a plurality of photographing positions. A number of photography and detection apparatuses having an RFID detection function and a photography function are arrayed in the positions where roads cross each other, and detect the RFID of a moving object which passes the photographing positions and transmit the image data of the moving object in association with the detected RFID to the server system. The server system stores the data of images photographed in a plurality of photographing positions in the storage device and retrieves the image data associated with the designated RFID from the storage device.

This is a continuing application of U.S. patent application Ser. No. 10/953,054, filed Sep. 29, 2004, which claims the benefit of priority from Japanese Patent Application No. 2004-104723, filed Mar. 31, 2004. The disclosures of each of these applications are incorporated by reference herein in their entirety.

### BACKGROUND OF THE INVENTION

1. Field of the Invention

The present invention relates to a method of retrieving image data of a moving object using RFID, an apparatus for photographing and detecting a moving object, an apparatus for retrieving image data of a moving object, a program for retrieving image data of a moving object, and a recording medium for recording an image data program.

2. Description of the Related Art

In recent years, with the advance of a multi-media image technology which is represented by a digital compression technology of motion pictures, image information services have been provided in various fields, and further speedup and high quality are required.

Particularly, a great deal is expected of the service of providing image information having a wide range of applications such as an application of detecting and recording the moving state of an object which is moving in a general life environment such as man, goods, vehicle or the like.

The work of setting a fixed camera in a plurality of photographing positions, retrieving a moving object such as man, goods, vehicle or the like from the images photographed by the camera, and creating image data of a specific object to which attention is paid relied, in the past, on the method how a person who is well aware of the moving object such as a specific man, goods, vehicle or the like finds out the moving object from a vast amount of image data with his own hands (namely, on the method of visual retrieval). In this method, however, since man, goods, vehicle or the like must be found out from an image data file for the images photographed separately in a plurality of photographing positions, though it is unknown whether the man, goods, vehicle or the like is included in the image-data file, the accuracy of retrieval is very low, and a tremendous lot of time is required, thus making the efficiency of retrieval process very inefficient.

In recent years, the method of retrieving a moving object by image recognition using the method of pattern recognition or pattern matching has been put to practical use owing to the renovation of an image signal processing technology. However, there are a lot of problems with said method in providing a general service in a wide range of fields because how to photograph an image is difficult (when an image is photographed from a diagonally backward angle, the image cannot be practically detected); how to photograph an image depends largely on the size of the image; the amount of arithmetic processing at an image data level is huge; and so on and so forth.

Described in patent document 1 is an image recording and playback apparatus which can three-dimensionally measure even an object having a large amount of movement in detail, comprising a visual-field frame setting device enlarging or reducing a visual field to any arbitrary size and an image processing device computing a plurality of three-dimensional coordinates to which attention is paid when an moving object is photographed by a plurality of photography apparatuses.

A system which collects an expressway toll using the RFID (Radio Frequency Identification) of an IC card having a radio transmission function has been introduced, and vehicles can be also identified using RFID.

Patent document 1: Kokai (Japanese unexamined patent publication) No. 8-242467

### SUMMARY OF THE INVENTION

In the conventional image accumulation system for moving objects, there was a problem in that since it was necessary to visually confirm a large number of images accumulated and retrieve the image of a specific object, it took a long time to retrieve the image.

The purpose of the present invention is to efficiently retrieve image data of a specific moving object from the data of images photographed in a plurality of photographing positions.

The moving object image-data retrieval method of the present invention is the image data retrieval method for receiving the image data of a moving object which is photographed and encoded in a plurality of photographing positions, and retrieving the image data of the specific moving object form the image data received. This method detects the RFID of the moving object which passes the photographing positions by a detection device, associates the image data of the moving object with the RFID detected and transmits the image data of the moving object associated with the RFID detected, stores the image data of the moving object associated with the RFID transmitted from the photographing positions in a storage device, and retrieves the image data of the image associated with the same RFID from a plurality of image data stored in the storage device.

According to this invention, it is possible to retrieve the image data of a moving object having a specific RFID from a vast amount of data of images photographed in a plurality of photographing positions. Thus, it is possible, for example, to extract image data of a specific moving object photographed in a plurality of photographing positions, collect it as a image data file and confirm which path the moving object moves through.

The other image data retrieval method of the present invention is the image data retrieval method for receiving the image data of a moving object which is encoded photographed in a plurality of photographing positions and retrieving the image data of a specific moving object from the image data received. This method receives the image data associated with the RFID of the moving object detected in a plurality of photographing positions, stores a plurality of image data associated with the RFID received, and retrieves the image data associated with the same RFID from the plurality of image data stored.

According to this invention, it is possible to retrieve the image data of a moving object associated with a specific RFID from a vast amount data of images photographed in a plurality of photographing positions.

Another embodiment of the image data retrieval method of the present invention writes at least the detected RFID in the position corresponding to the image data in plurality of photographing positions, retrieves the RFID from among a plurality of image data files stored in the storage device, and extracts the image data in which the same RFID is written.

Thus, by constituting the method in such a way, the image data of a moving object having a specific RFID can be extracted from a vast amount image data by retrieving the RFID written in the image data file and extracting the image data in which the same RFID is written.

Another embodiment of the image data retrieval method of the present invention makes and transmits a moving object detection information file which associates the RFID of the detected moving object with the detection time and the image data file including the image data of the moving object associated with the RFID in a plurality of photographing positions, retrieves a specific RFID from among a plurality of image data files transmitted from a plurality of photographing positions, acquires the image data in which the same RFID is written, and rearranges the acquired image data chronologically based on the detection time of the RFID stored in the moving object detection information file transmitted from a plurality of photographing positions.

Thus, by constituting the method in such a way, it is possible to acquire the image data of a specific moving object from among a number of image data files and rearrange the image data chronologically in the order of the time when the moving object passes the photographing positions.

The moving object photography and detection apparatus of the present invention is a moving object photography apparatus which is arrayed in a plurality of photographing positions within a certain area and which is used for an image accumulation system for accumulating image data transmitted from each photography apparatus. This apparatus comprises a photography device photographing a moving object, an encoding device encoding images photographed by the photography device, a storage device storing image data encoded by the encoding device, a detection device detecting the RFID of the moving object, an image data acquisition unit storing the image data of the moving object in association with the detected RFID in the storage device, and a transmission device transmitting the image data associated the RFID.

According to this invention, the image data of a moving object having a specific RFID can be easily retrieved from a vast amount of image data on the side of the accumulation system for accumulating the image data by transmitting the image data of the moving object in association with the detected RFID. Thus, it is possible to extract, for example, the image data of a specific moving object photographed in a plurality of photographing positions, collect said image data as an image data file, and confirm which path the moving object passes through.

In another embodiment of the photography and detection apparatus of the present invention, the image data acquisition unit writes the detected RFID to the corresponding position of the image data file, in the above invention.

By constituting the apparatus in such a way, since the RFID is written in the position where the image data to which the image data file corresponds is stored, the image data of the moving object having a specific RFID can be retrieved by retrieving that RFID.

Another embodiment of the moving object photography and detection apparatus of the present invention has a device which makes an image data file including the image data associated with the detected RFID and a moving object detection information file which associates the RFID of the detected moving object with the detection time in plurality of photographing positions, in the above invention.

By constituting the apparatus in such a way, the apparatus which receives and accumulates the image data of a plurality of photographing positions can extract the image data of a moving object having a specific RFID from among a number of image data files and rearrange the extracted image data chronologically in the order of the time when the moving object passes a plurality of photographing positions.

The moving object image-data retrieval apparatus of the present invention receives the image data of a moving object which is photographed, encoded and transmitted by the photography apparatuses installed in a plurality of photographing positions, and retrieves the image data of a specific moving object from the image data received. The moving object image-data retrieval apparatus comprises a receiving device receiving a moving object detection information file which associates the RFID of the moving object detected in a plurality of photographing positions with the detection time of the moving object and the image data associated with the detected RFID, a storage device storing the moving object detection information file and the image data of a plurality of photographing positions received from the receiving device, and a retrieval device retrieving the image data in which the same RFID is written from a plurality of image data stored by the storage device.

According to this invention, it is possible to retrieve the image data of a moving object having a specific RFID from a vast amount of data of images photographed in a plurality of photographing positions. Thus, it is possible to extract, for example, the image data of a specific moving object photographed in a plurality of photographing positions, collect it as one image data file and confirm which path the moving object passes through.

Another embodiment of the image data retrieval apparatus of the present invention has an index information making device making the index information which associates the RFID with the information indicating the position which stores the RFID on the image data file.

By constituting the apparatus in such a way, the position in which the image data of the specific RFID is stored can be known by the index information, so the retrieval of image data can be speeded up because it is possible to find out the image data to be targeted without retrieving the image data file itself.

The index information corresponds to, for example, a real-time index file 43 shown in FIG. 4.

Another embodiment of the image data retrieval apparatus of the present invention has an edition device rearranging the image data of a specific moving object chronologically in the order of the time when the moving object passes a plurality of photographing positions based on the information associated with the detection time of the RFID in each photographing position and the detected RFID.

By constituting the apparatus in such a way, it is possible to retrieve the image data of a specific moving object from a vast amount of data of images photographed in each photographing position and rearrange the retrieved image data chronologically in the order of the time when the moving object passes each photographing position.

Another image data retrieval apparatus of the present invention receives the image data of moving objects which are photographed, encoded and transmitted by the photography apparatuses installed in a plurality of photographing positions, and retrieves the image data of a specific moving object from the image data received. The image data retrieval apparatus comprises a receiving device receiving a moving object detection information file which associates the RFID of the moving object detected in a plurality of photographing positions with the detection time of the moving object and the image data associated with the detected RFID, a storage device storing the moving object detection information file and the image data of a plurality of photographing positions received from the receiving device, a retrieval device retrieving the image data associated with the same RFID from a plurality of image data stored by the storage device, and a distribution device distributing the image data of the specific moving object detected by the retrieval device to a user.

According to this invention, it is possible to retrieve the image data of a moving object having a specific RFID from a vast amount of data of images photographed in a plurality of photographing positions and provide the retrieved image data acquired in a plurality of photographing positions to a user. Thus, it is possible to realize, for example, the service of editing the image data of a specific moving object photographed in a plurality of photographing positions to the format of image data which the user desires (such as photographing time, photographing position, photographing conditions) and distributing said image data to the user.

### BRIEF DESCRIPTION OF THE DRAWINGS

FIG. 1 shows the basic configuration of the present invention.

FIG. 2 shows the system configuration of the embodiment.

FIG. 3 is a flowchart showing the processing of the photography and detection apparatus in a first embodiment.

FIG. 4 shows the moving object detection information file and the real-time index file.

FIG. 5 is a flowchart showing the process of calculating the start position and end position for acquiring image data.

FIG. 6 is an explanatory drawing when image data beyond the RFID detection range is acquired.

FIG. 7A and FIG. 7B are flowcharts showing the process of making a real-time index file.

FIG. 8 shows the index file of a time stamp.

FIG. 9 shows the operation of the photography and detection apparatus.

FIG. 10 shows the transfer pattern of data of images photographed by a plurality of cameras.

FIG. 11A and FIG. 11B are flowcharts showing the processing of the server system in the first embodiment.

FIG. 12 shows the processing of the photography and detection apparatus and the server system.

FIG. 13 shows the file used for the edition processing.

FIG. 14 shows an example of the process of editing image data of a plurality of positions.

FIG. 15A and FIG. 15B are flowcharts showing the processing of the server system in the second embodiment.

FIG. 16A and FIG. 16B are flowcharts showing the processing of the photography and detection apparatus in the third embodiment.

FIG. 17 shows the process of writing the data of a RFID tag.

FIG. 18 shows the configuration of the hardware.

### DESCRIPTION OF THE PREFERRED EMBODIMENTS

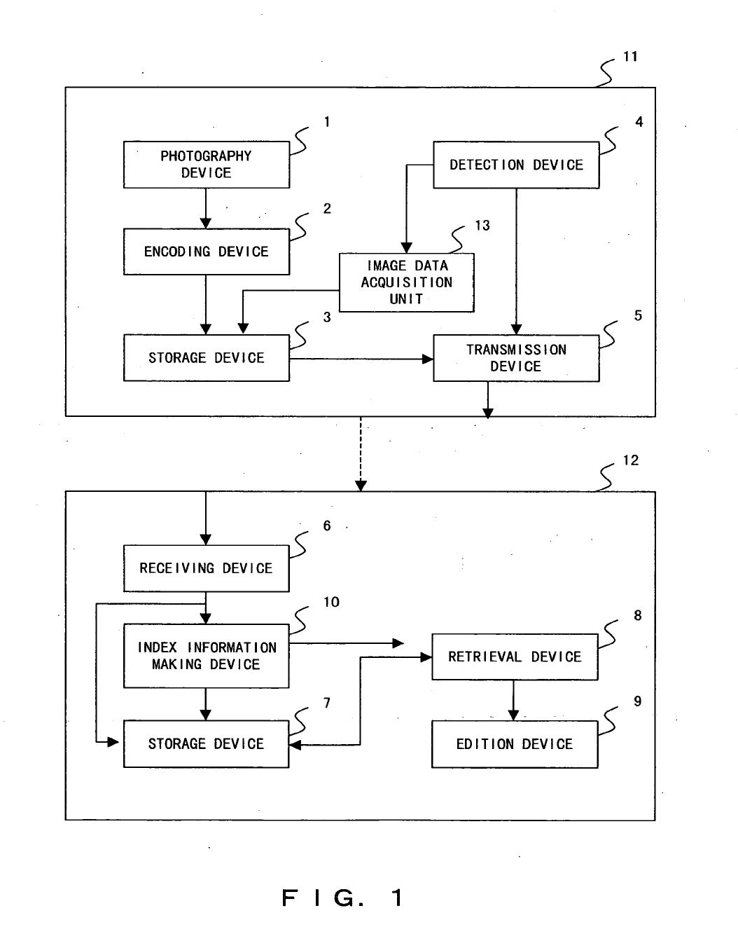

Described below are the embodiments of the present invention with reference to the accompanying drawings. FIG. 1 shows an example of the basic configuration of a moving object photography and detection apparatus 11 and an image data retrieval apparatus 12 of the present invention.

The moving object photography and detection apparatus 11 is a photography apparatus which is arrayed in a plurality of photographing positions and which photographs a moving object which is used for the image accumulation system which accumulates image data transmitted from each photography apparatus. The moving object photography and detection apparatus 11 comprises a photography device 1 photographing a moving object, an encoding device 2 encoding images photographed by the photography device 1, a storage device 3 storing image data encoded by the encoding device 2, a detection device 4 detecting the RFID of a moving object, an image data acquisition unit 13 storing the image data of the moving object in association with the detected RFID in the storage device 3, and a transmission device 5 transmitting the image data associated with the RFID.

According to this configuration, the image data of a moving object having a specific RFID can be easily retrieved from a vast amount of image data on the side of the accumulation system for accumulating the image data by transmitting the image data of the moving object in association with the detected RFID. Thus, it is possible to extract, for example, the image data of a specific moving object photographed in a plurality of photographing positions, collect it as an image data file, and confirm which path the moving object passes through.

The image data retrieval apparatus 12 of the present invention receives the image data of moving objects which are photographed, encoded and transmitted by the photography apparatuses installed in a plurality of photographing positions, and retrieves the image data of a specific moving object from the image data received. The moving object image-data retrieval apparatus 12 comprises a receiving device 6 receiving a moving object detection information file which associates the RFID of the moving object detected in a plurality of photographing positions with the detection time of the moving object and the image data associated with the detected RFID, a storage device 7 storing the moving object detection information file of a plurality of photographing positions received from the receiving device 6 and the image data, and a retrieval device 8 retrieving the image data in which the same RFID is written from a plurality of image data stored by the storage device 7.

According to this configuration, it is possible to retrieve the image data of a moving object having a specific RFID from a vast amount of data of images photographed in a plurality of photographing positions. Thus, it is possible to extract, for example, the image data of a specific moving object photographed in a plurality of photographing positions, collect it as one image data file and confirm which path the moving object passes through.

The image data retrieval apparatus 12 also has an index information making device 10 making the index information which associates the RFID with the information indicating the position storing the RFID in the image data file.

Since the position in which the image data of the specific RFID is stored can be known by the index information, the retrieval of image data can be speeded up because it is possible to find out the image data to be targeted without retrieving the image data file itself.

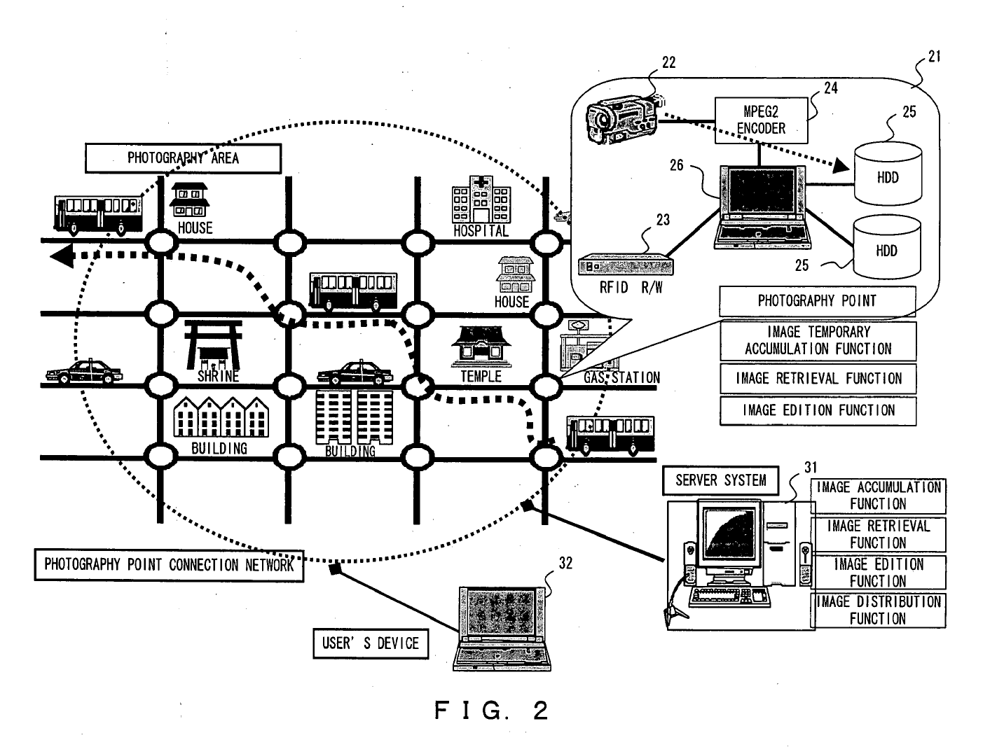

FIG. 2 shows the configuration of the moving object photographing and image retrieval system using the RFID of the embodiment.

A photography and retrieval apparatus 21 comprises a camera 22, a RFID reader-writer 23 (R/W), an MPEG 2 encoder 24 encoding the image photographed by the camera 22 by the MPEG 2 method and a data processing device 26 (such as a personal computer) which performs the process of storing the encoded image in a storage device 25 such as a hard disk and the process of recording the image data and the RFID tag (TAG) number (moving object identification information) detected by the RFID reader-writer 23.

A number of photography and retrieval apparatuses 21 which are arrayed in the positions shown in FIG. 2 where roads cross each other photograph moving objects such as vehicles which are running on the roads and transmit encoded image data to the server system 3.

The server system (image data retrieval apparatus) 31 has an image accumulation function for accumulating the image data transmitted from the photography and detection apparatus 21 installed in each photographing position in a storage device such as a hard disk, an image retrieval function for retrieving the image data of a specific moving object from the accumulated image data, an image edition function for editing the retrieved image data into an image data file by arranging said data chronologically, and an image distribution function for distributing the edited image data to a user's device 32 according to a periodical request or a request from a user. The image accumulation function, image retrieval function, image edition function and image distribution function of the server system 31 may be realized by any other device.

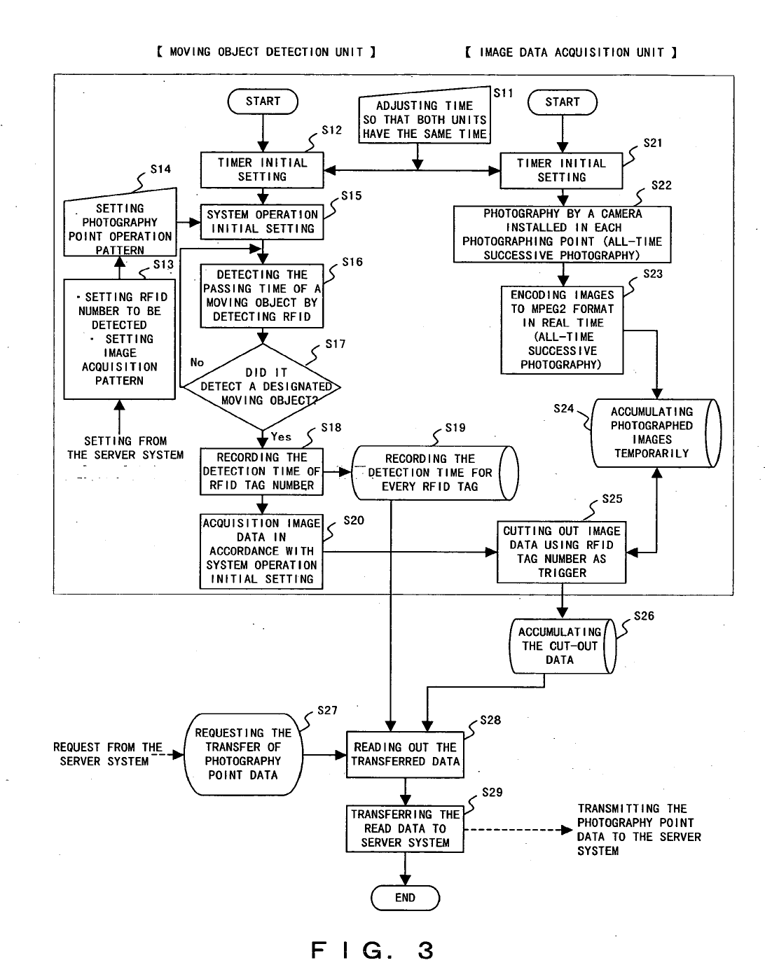

Next, described below is the processing of the photography and detection apparatus 21 which is constituted as described above with reference to the flowchart shown in FIG. 3.

The left-side flow surrounded by a solid line shown in FIG. 3 shows the processing of the moving object detection unit (which corresponds to a part of the function of the RFID reader-writer 23 and the data processing device 26), and the right-side flow surrounded by a solid line shown in FIG. 3 shows the processing of the image data acquisition unit (which corresponds a part of the function of the camera 22, the MPEG 2 encoder 24 and the data processing device 26).

First, the time of the moving object detection unit and that of the image data acquisition unit are adjusted for both devices to have exactly the same time (S11 in FIG. 3). Then, the initial setting processing of the timer of the moving object detection unit and the image data acquisition unit is implemented (S12 and S21).

The moving object detection unit sets the RFID tag number of the object of detection instructed from the server system (server apparatus) 31 and sets the image acquisition pattern (S13). The image acquisition pattern is, for example, the information which designates how long the image data should be recorded after RFID is detected.

Then, the moving object detection unit sets a photography point operation pattern (S14). The photography point operation pattern is the information which designates the photographing operation and detection operation of the photography and detection device 21.

The moving object detection unit implements the system operation initial setting processing based on the information set in Steps S13 and S14 (S15).

Then, the moving object detection unit detects the RFID of a moving object which passes the photographing positions and detects the passing time of the moving object (S16), and after then, judges whether it has detected the designated moving object, namely, whether the detected RFID tag number conforms to the designated RFID tag number (S17).

If said RFID tag numbers do not agree (S17, NO), the moving object detection unit goes back to Step S1 and repeats the detection of RFID.

If the detected RFID tag number conforms to the designated RFID tag number (S17, YES), the moving object detection unit proceeds to Step S18 and records the detection time of the RFID tag number. Then, the moving object detection unit associates the detection time with the RFID tag number, and stores the detection time associated with the RFID tag number in the storage device 25 as moving object detection information (S19).

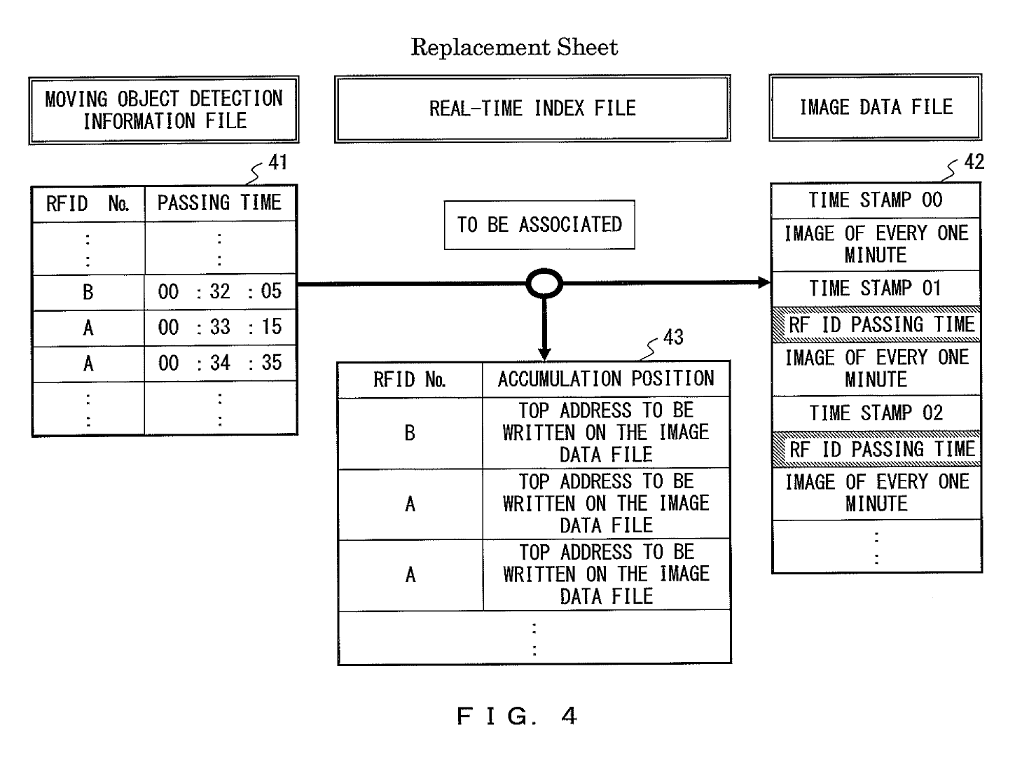

The moving object detection information is the information which consists of the RFID tag number detected by the RFID reader-writer and the detection time, and each detection time for each detected RFID tag number is recorded in the moving object detection information file 41 shown in FIG. 4.

In FIG. 3, the moving object detection unit instructs the image data acquisition unit how many seconds the image data acquisition unit should obtain image data and how many seconds before the detection time of the RFID tag number based on the system operation initial setting value (S20).

The image data acquisition unit successively photographs a moving object on a road using a camera, and converts the photographed image to image data of the MPEG2 format by the encoder 24 (S23), and then, temporarily stores the image data encoded by the MPEG2 format in the storage device 25 (S24).

If the image data recorded in the storage device 25 is not used for a given period of time, the image data is automatically overwritten and deleted. For example, when a designated RFID is not detected, it is not necessary to keep the image data saved, so the memory capacity of the storage device 25 can be reduced by overwriting image data, and the cost of the photography and detection apparatus 21 can be reduced.

Then, the image data acquisition unit cuts out image data using the detection of the RFID tag number as a trigger in accordance with the instruction from the moving object detection unit of Step S20 (S25). This cutting-out of image data is implemented, for example, by reading out the image data acquired for a period during which a given time passes from a given time before the detection time of the RFID designated by the system operation initial setting value.

The image data acquisition unit associates the cut-out image data with the detected RFID tag number and stores the cut-out image data associated with the detected RFID tag number in the storage device 25 (S26). This association of the image data and the RFID tag number is implemented, for example, by writing the RFID tag number to the header part of the data of the image photographed at the same time as the detection time of the RFID.

Then, when the server system 31 requests each photography and detection apparatus 21a, 21b . . . 21n to transfer the image data (S27), the photography and detection apparatus 21 reads out the image data file 42 including the image data associated with the RFID tag (refer to FIG. 4) from the storage 25 (S28), and transmits the read image data file 42 to the server system 31 (S29).

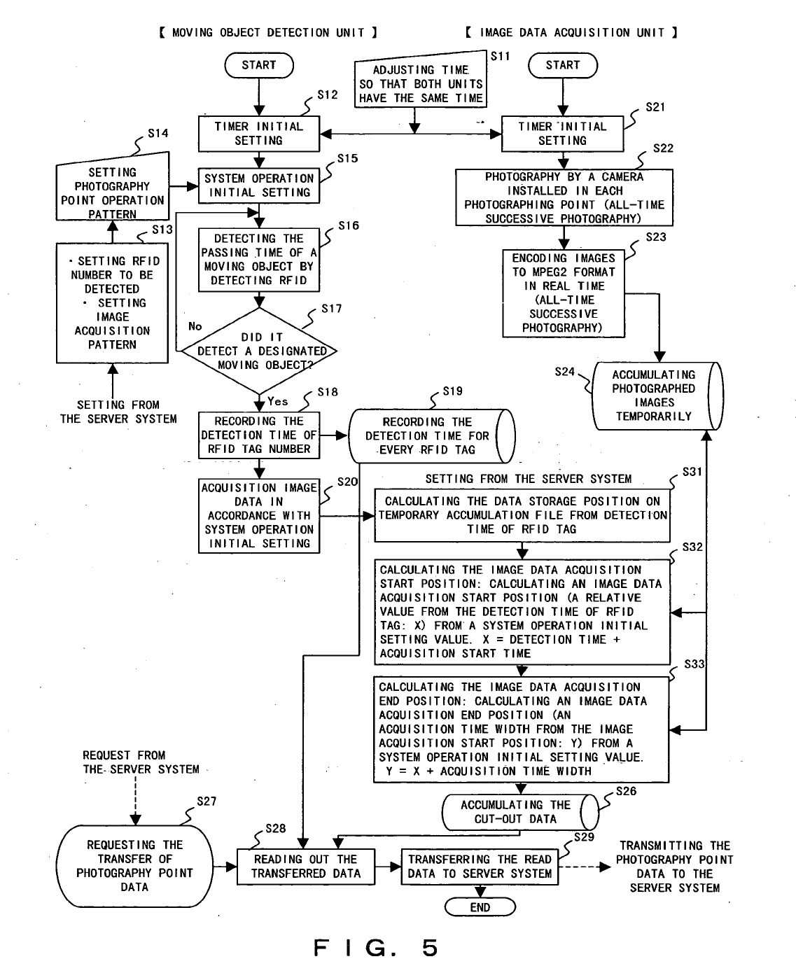

FIG. 5 is a flowchart showing the process of calculating the start position and end position for acquiring RFID, which is added to the flowchart shown in FIG. 3. In the following description, the same Step number is given to the same processing as in FIG. 3.

The server system 31 calculates a data storage position on a temporary accumulation file (image data file) on the basis of the detection time of the RFID tag in Step S31 shown in FIG. 5.

Then, the server system 31 calculates an image data acquisition start position X according to the detection time of the RFID tag and the image acquisition start time determined by a system operation initial setting value, namely how many seconds before the detection time of the RFID tag the image data should be acquired (S32).

Then, the server system 31 calculates an image data acquisition end position Y from the image data acquisition start position X acquired in Step S32 and the acquisition time width determined by the system operation initial setting value (S33).

By the above processing, the image data is acquired for a period during which a given time passes from a given time before the time set by the system operation initial setting value, and is stored in the storage device 25 as an image data file 42. The stored image data file 42 is transmitted together with the moving object detection information file 41 (refer to FIG. 4) which records the detection time of every RFID tag to the server system 31.

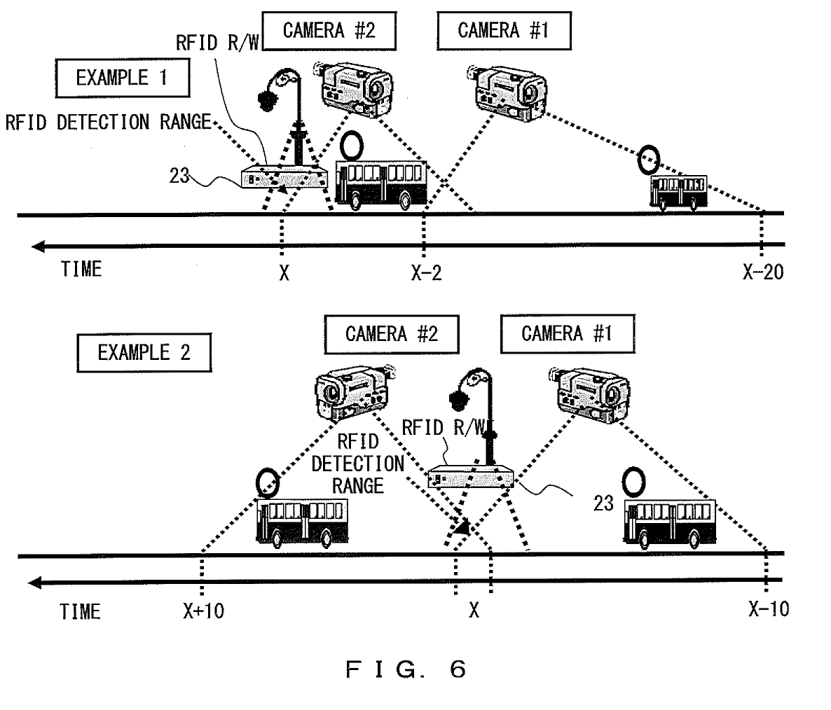

FIG. 6 is an explanatory drawing when image data beyond the RFID detection range is acquired by acquisition the image data of a given time before the detection time of the RFID.

The photography and detection apparatus 21 calculates the image data acquisition start position and end position shown in Example 1 or Example 2 of FIG. 6 based on the system operation initial setting value.

Example 1 of FIG. 6 shows that two cameras #1 and #2 successively photograph a moving object running on the road, and when a specific RFID is detected by the RFID reader-writer 23, all the image data from the image data photographed by camera #1 in the position twenty seconds before the detection time X of the RFID to the image data of the detection time X of the RFID photographed by camera #2 is acquired.

Example 2 shows that all the image data from the image data photographed by camera #1 ten seconds before the detection time X of the RFID tag to the image data photographed ten seconds after the detection time X of the RFID is acquired.

Thus, an image of a moving object beyond the RFID detection range can be recorded by acquiring the image photographed a give time before the detection time of the RFID of a specific moving object and the image data of the image photographed a given time after the detection time.

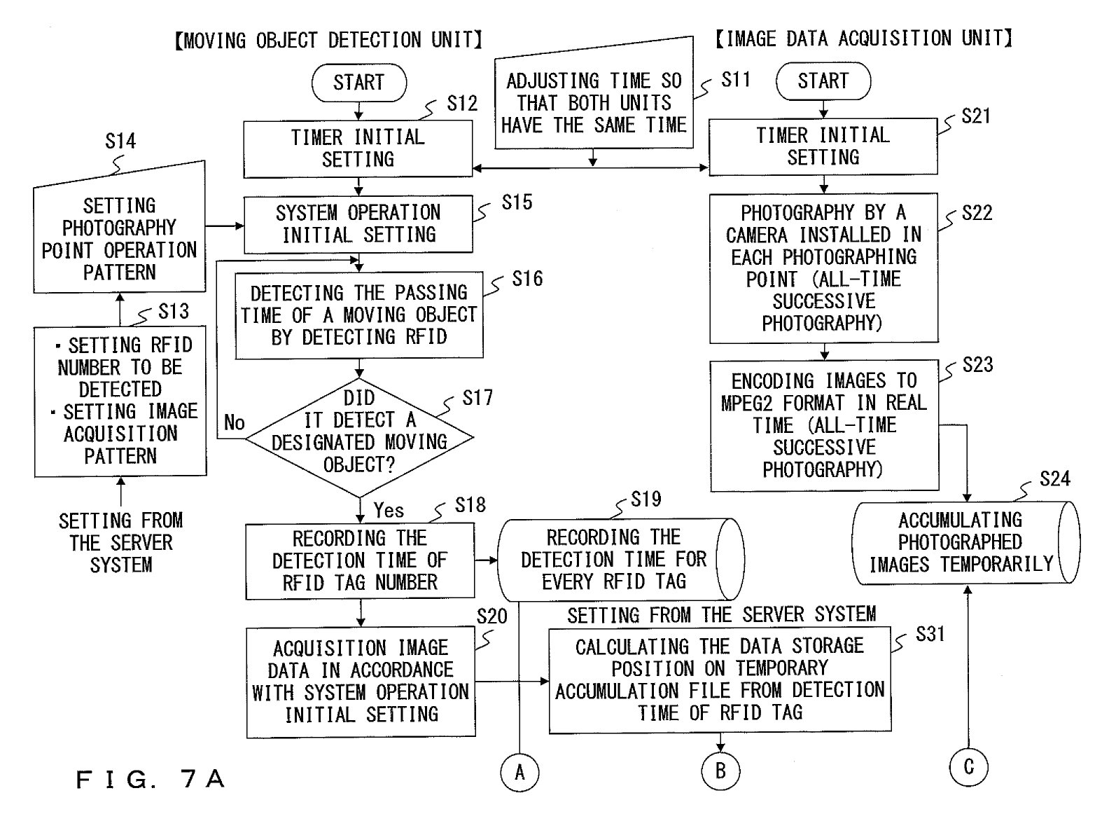

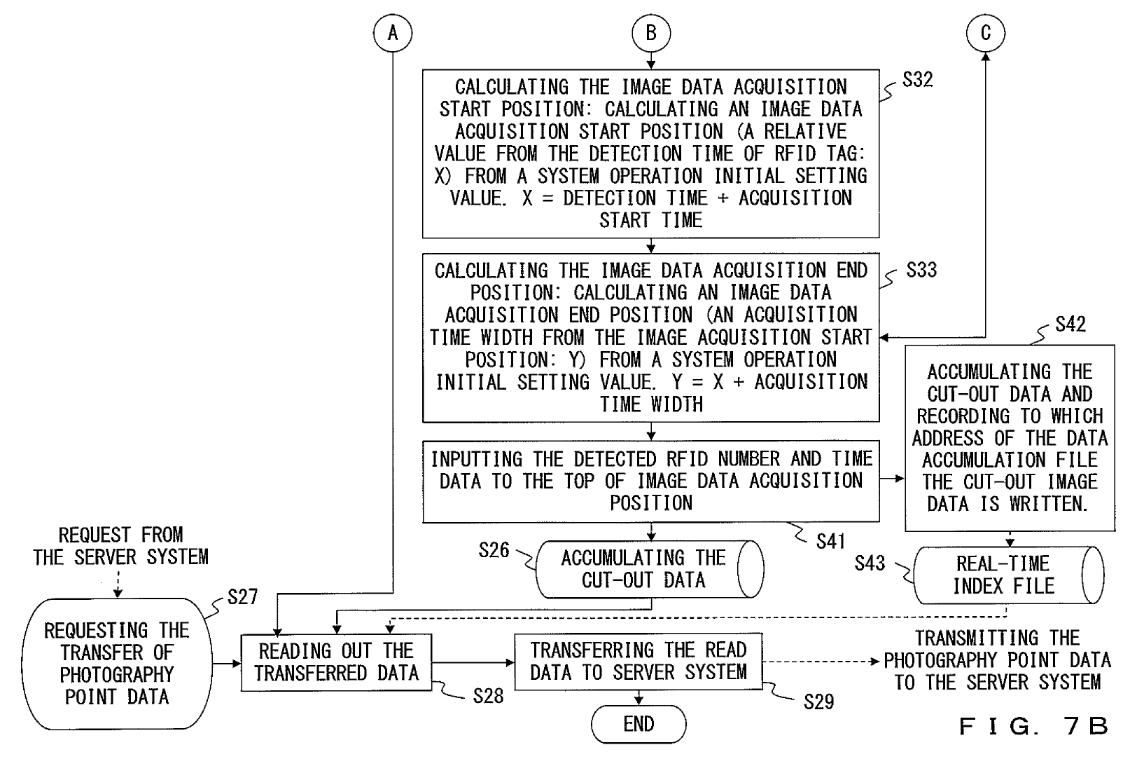

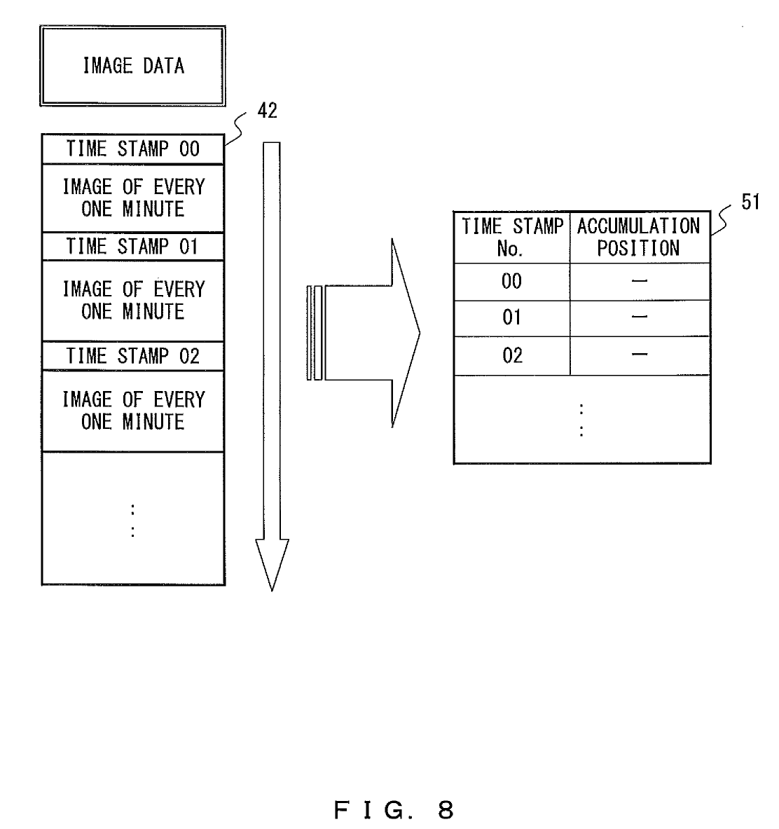

FIG. 7 and FIG. 7B are flowcharts showing the process of making a real-time index file 43 (FIG. 4) which records the top address to be written on the image data file for every RFID tag number. The same Step number is given to the same processing as in the flowchart shown in FIG. 3 and FIG. 5.

In Step 41 of FIG. 7B, the server system 31 inputs the RFID tag number detected by the RFID reader-writer 23 and the time data to the header part of the top image data in the image data acquisition start position (the acquisition start position calculated in Step 32 of FIG. 7B).

Then, the server system 31 stores the image data to which the RFID tag is inputted in the storage device 25, cuts out the image data to which the RFID tag number and the time data are inputted, and records to which address of the data accumulation file (image data file 42) the cut-out image data is written (S42).

Then, the server system 31 writes the information recorded in the real-time index file 43 which is associated with the RFID tag number and the top address to be written on the image data file 42 (S43).

By the above processing, when a moving object having a designated RFID tag number is detected by each photography and detection apparatus 21a, 21b . . . 21n, the RFID tag number and the time data are written to the top of the image data acquisition start position of the image data file 42, and the real-time index file 43 (refer to FIG. 4) which associates the storage address on the image data file 42 of the image data in which said data is written with the RFID tag number is made. Thus, the server system 31 can find out the image data of the targeted moving object by retrieving the real-time index file 43 using the RFID tag number as a key.

Described below are the data written to the image data file 42 in Steps S41 to S43 and the real-time index file 43 with reference to FIG. 4.

Image data of every one minute with a time stamp added is recorded in the data file 42 shown in FIG. 4, and the detected RFID tag number and the passing time (detection time) data are written in the header part of the image data of the time corresponding to the detection time of the RFID or in the header part of the image data corresponding to the image data acquisition start position determined by the system operation initial setting value.

Also, the real-time index file 43 which associates the RFID tag number with the top address written on the image data file 42 of the image data in which the RFID tag number is written is made.

In general, the method is well known which makes the index file 51 which associates the time stamp of the image data file 42 with the accumulation position of the image data and retrieves the image data of any arbitrary time using the index file 51.

It is difficult, however, to retrieve the image data of a specific moving object in real time by means of the method of retrieving image data based on the index file of the time stamp.

According to this embodiment, when the RFID tag number of a moving object is identified by using the real-time index file 43, the stored position of the image data of the moving object can be directly found out by the RFID tag number, so it is possible to retrieve the image data of the moving object at a high speed.

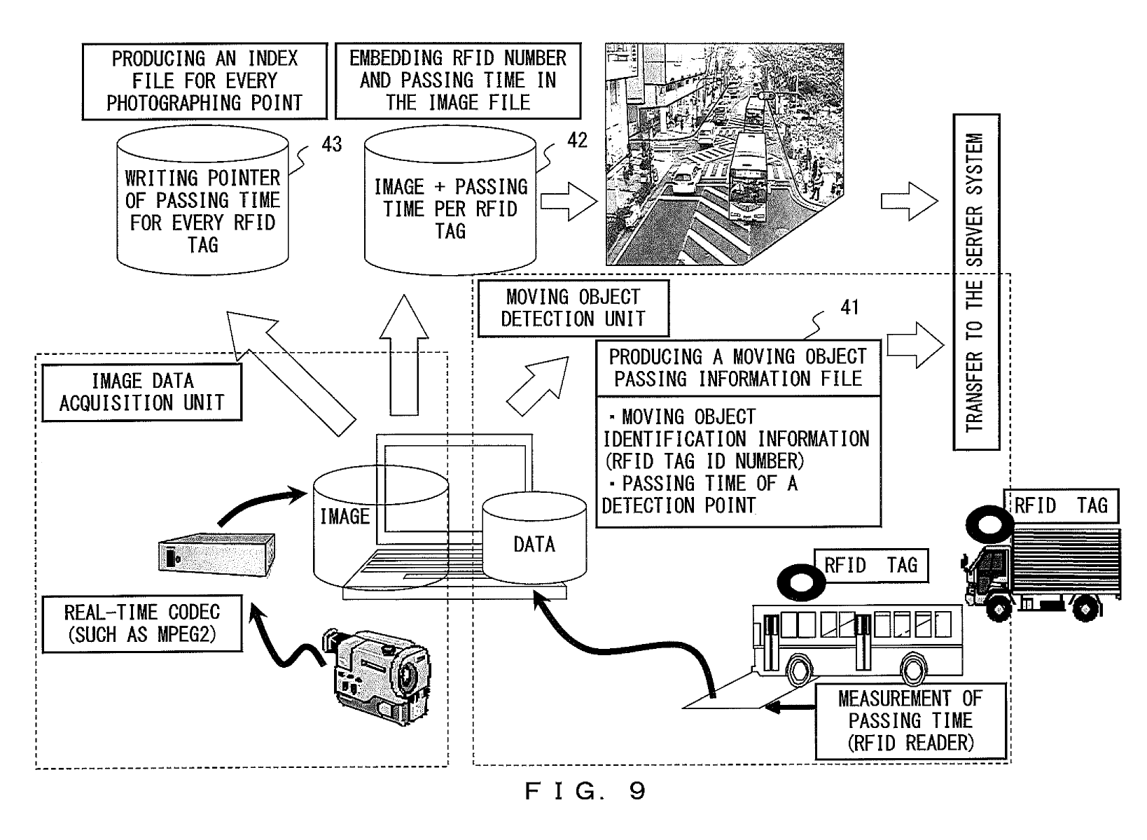

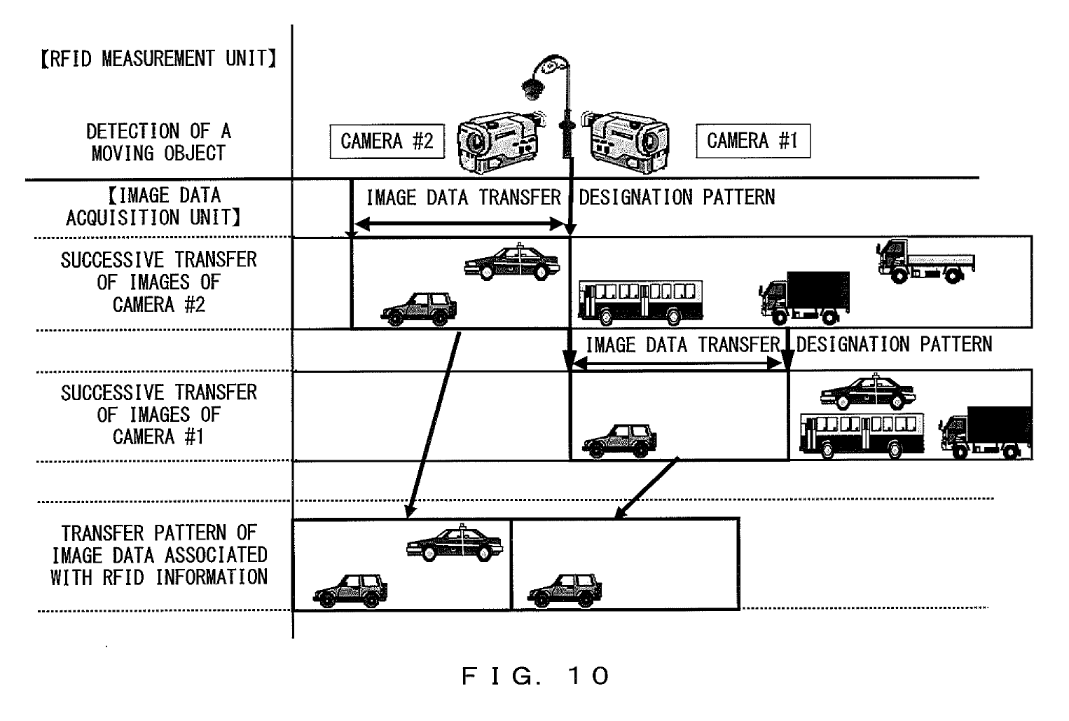

Described below is the operation of the photography and detection apparatus 21 with reference to FIG. 9 and FIG. 10.

The moving object detection unit of the photography and detection apparatus 21 produces a moving object passing information file 41 which associates the moving object identification information (RFID tag number) of the moving object which passes the photographing positions with the passing time.

For example, when two cameras photograph a vehicle running on the road as shown in FIG. 10, if a specific RFID tag number is detected at a certain time, the image data acquisition unit acquires the image data at a given time on the basis of the passing time based on the image acquisition pattern (image data transfer designated pattern) determined by the system operation initial setting value.

In FIG. 10, the image acquisition unit reads out the image data photographed by camera #1 a given time before the detection time of the RFID tag and the image data photographed by camera #2 a given time after the detection time from the storage device 25, and collects said image data into one image data file 42.

In FIG. 9, the control device of the photography and detection apparatus 21 (which corresponds to the data processing apparatus 26) embeds the RFID tag number of a moving object which passes the photographing positions and the passing time in the corresponding image data in the image data file 42.

Also, the control device-of the photography and detection apparatus 21 produces a real-time index file 43 which associates the RFID tag number with the storage address on the image data file 42 of the images in which the RFID tag number is written.

The moving object detection information file 41, the image data file 42 and the real-time index file 43 are transferred to the server system 31. Only the image data file 42 and the moving object detection information file 41 may be transferred to the server system 31.

Thus, the server system 31 can automatically retrieve the image data of an arbitrary moving object without having to visually checking the image data file 42 by writing the RFID tag number and the passing time of the moving object photographed at a certain position to the corresponding position (for example, the header part of the corresponding image data) of the image data file 42, and transmitting the image data file 42 to the server system 31.

Also, the server system 31 can acquire the storage address of the image data of a moving object photographed in each photographing position and read out any necessary image data without retrieving a number of image data files 42 by making the real-time index file 43 which associates the RFID tag number of the moving object which passes each photographing position with the storage address of the image data of the corresponding moving object on the image data file 42. Thus, it is possible to shorten the retrieval time of the image data to a great extent.

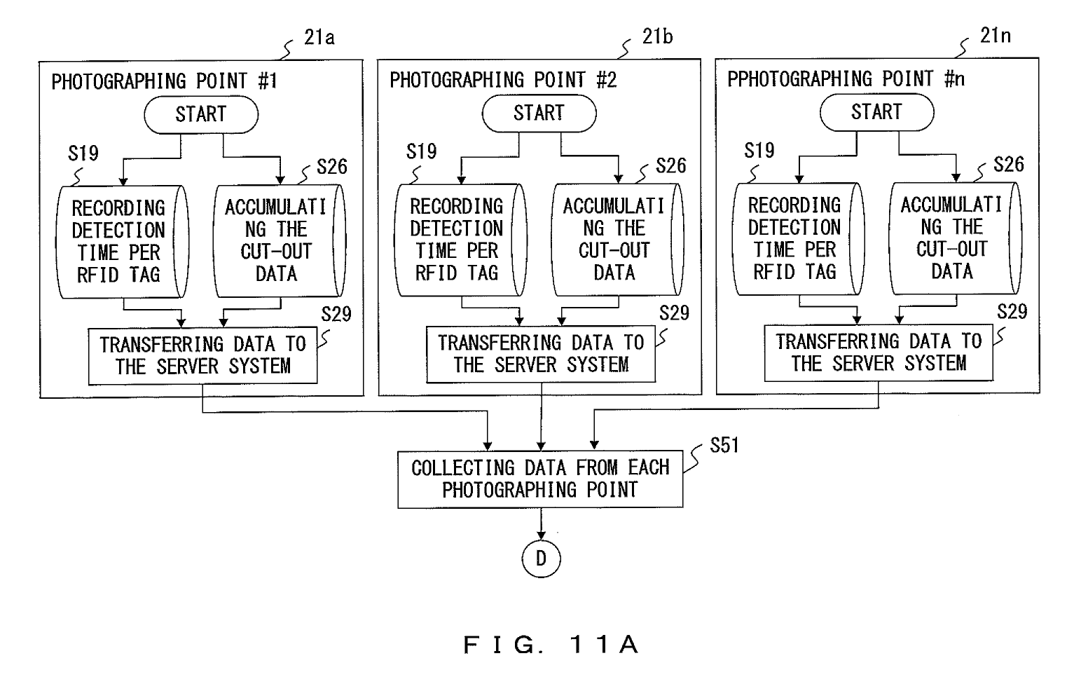

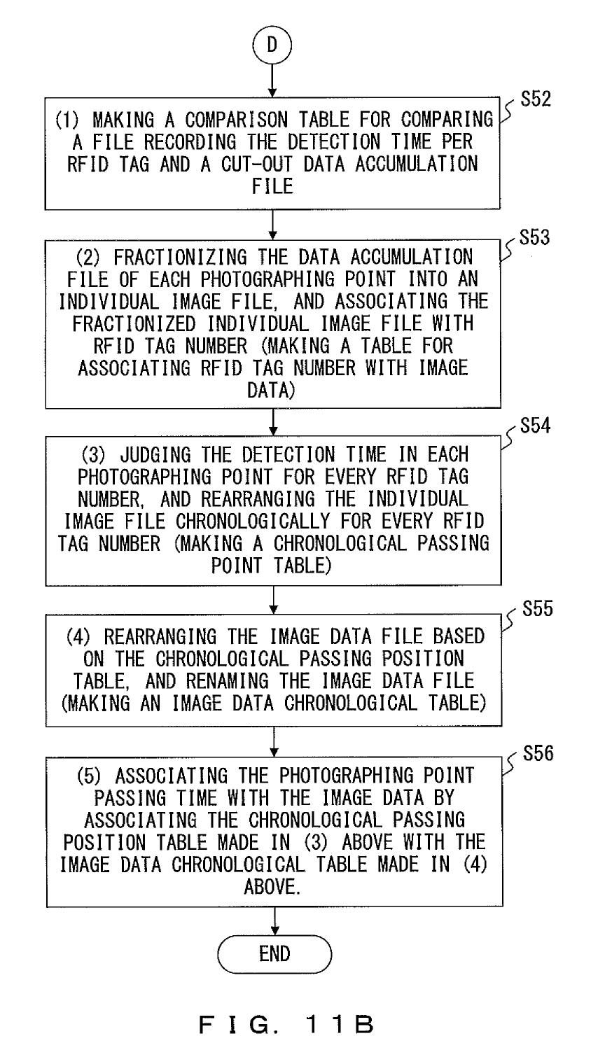

Next, described below is the processing of the server system 31 in a first embodiment with reference to the flowchart shown in FIG. 11A and FIG. 11B. The same Step number is given to the same processing as in FIG. 3.

Each photography and detection apparatus 21a, 21b . . . 21n makes the moving object detection information file 41 which records the detection time for every RFID tag number and stores said file 41 in the storage device 25 (S19 in FIG. 11A).

Also, each photography and detection apparatus 21a, 21b . . . 21n cuts out the image data of a moving object designated by an RFID tag number, makes the image data file 42 and stores it in the storage device 25 (S26), and then transfers the data to the server system 31 (S29).

The server system 31 collects the data transmitted from each photography and detection apparatus 21a, 21b . . . 21n installed in each photographing position (S51).

Then, the server system 31 makes a comparison table for comparing the moving object detection time recording file 41 indicating the detection time for every RFID tag number transmitted from each photography and detection apparatus 21a, 21b . . . 21n with the cut-out data accumulation file (S52).

Then, the server system 31 fractionizes the cut-out data accumulation file transmitted from each photography and detection apparatus 21a, 21b . . . 21n into an individual image file and makes an association table which associates the fractionized individual image file with the RFID tag number (S53).

Then, the server system 31 judges the detection time in each photographing position for every RFID tag number and makes a chronological passing position table which rearranges the passing position chronologically for every RFID tag number (S54).

From this chronological passing position table, it is possible to know in what order a specific moving object passes each photographing position when the specific moving object is photographed in a plurality of photographing positions including the same positions.

Then, the server system 31 rearranges the image data file 42 transmitted from a plurality of photographing positions based on the chronological passing position table made in Step S54, said file and makes an image data chronological table (S55).

Then, the server system 31 associates the passing time of each photographing position of a specific moving object with the image data by associating the chronological passing position table made in Step S54 with the image data chronological table made in Step S55 (S56).

Thus, it is possible to chronologically rearrange the image data of the specific moving object photographed in each photographing position based on the RFID tag number written in the image data file 42 and the moving object detection information file 41 of each photographing position.

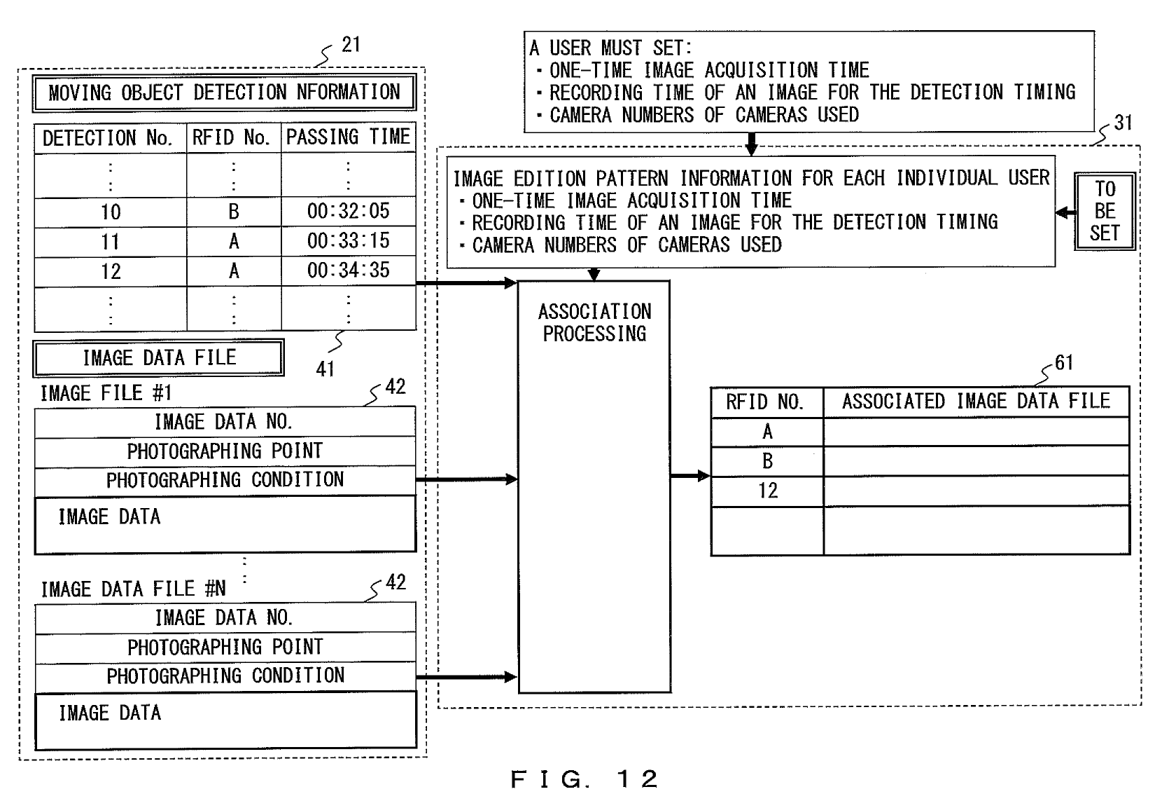

Described below is the processing of the photography and detection apparatus 21 and the server system 32 with reference to FIG. 12.

The photography and detection apparatus 21, when detecting a moving object, makes the moving object detection information file 41 which associates the RFID tag number, passing time and detection number (to be given in the order of detection) of the detected moving object, as shown in FIG. 12. Then, the photography and detection apparatus 21 makes the image data file 42 in which the RFID tag number of the moving object is written and transmits those files to the server system 31.

The server system 31 performs the process of associating the RFID tag number of the moving object detection information file 41 transmitted from each photography and detection apparatus 21a, 21b . . . 21n with the image data file 42 of each photographing position based on the information set by the system or the user. In this association processing, the server system 31 makes a file 61 which rearranges the image data file 42 of each photographing position in the order of detection time for every RFID tag number.

The information which the user sets is information such as one-time image acquisition time, recording time of an image for the detection timing of RFID, camera numbers of cameras used for photography, etc.

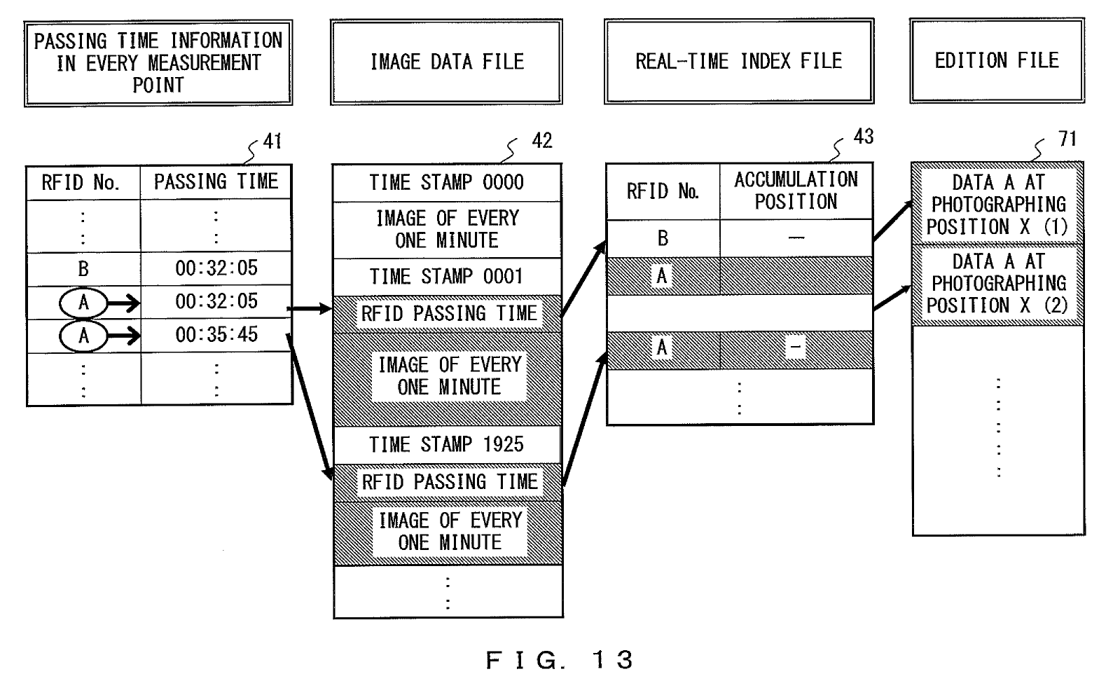

Described below is the file used for the edition processing of the server system 31 with reference to FIG. 13.

The server system 31 retrieves the RFID tag number embedded in the image data file 42 and makes the real-time index file 43 which associates the RFID tag number with the storage address.

Then, the server system 31 makes an edition file 71 which chronologically rearranges the storage address of the image data having the same RFID tag number and the image data of images photographed in each photographing position. Image data of a specific moving object photographed in each photographing position is chronologically stored in this edition file 71.

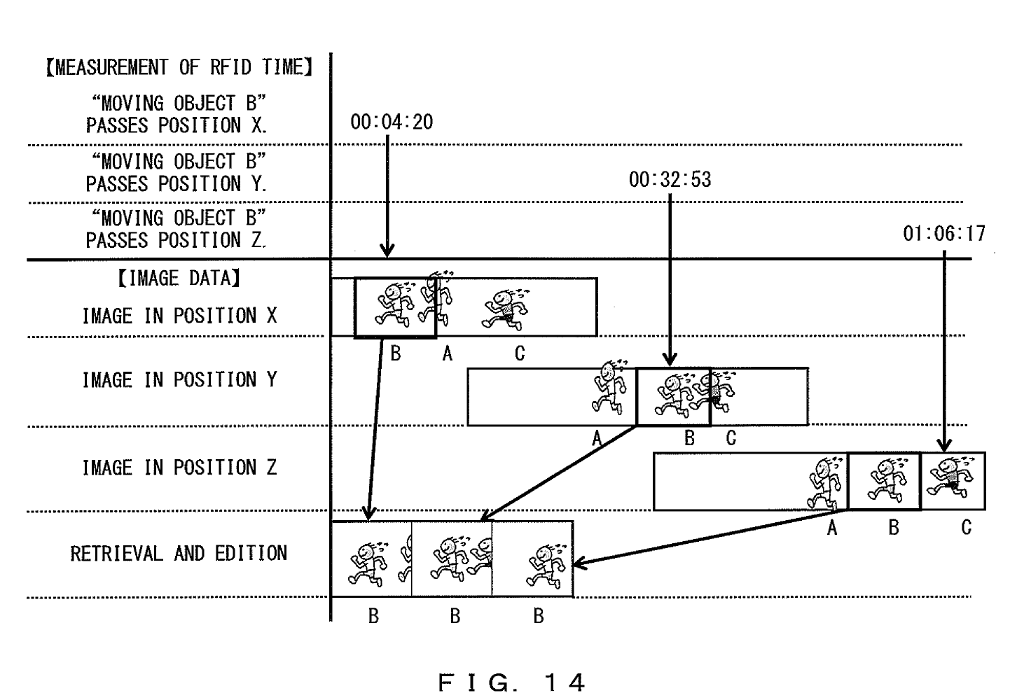

FIG. 14 shows an example of the process of editing the data of images photographed in a plurality of photographing positions.

The server system 31 is supposed to have received the image data file 42 of the moving object (in this example, a man) photographed in position X, position Y and position Z and the moving object detection information file 41 and to have been instructed to edit the image data of a moving object B.

The server system 31 retrieves the RFID tag number recorded in the image data file 42 and extracts the image data in which the detected RFID tag number is written. Then, the server system 31 cuts out the extracted image data (image data of moving object B in FIG. 14), rearranges the image data chronologically on the basis of the passing time, and makes one image data file.

Thus, it is possible to extract the image data of a specific moving object from a vast amount of data of images photographed in a plurality of photographing positions and make an image data file which rearranges the image data chronologically. It is also possible to provide the image data of the object which the user desires in almost real time by editing this image data file 42 based on the user's desire and distributing the edited image data file 42 to the user via a network.

In order to chronologically rearrange the data of images photographed in a plurality of photographing positions, it is not always necessary to make the real-time index file 43. The image data which has been chronologically rearranged can be acquired by retrieving the corresponding RFID tag number from the image data file 42 in which the RFID tag number transmitted from each photographing position is embedded and rearranging the image data having the same RFID tag number in the order of the detection time of the RFID tag.

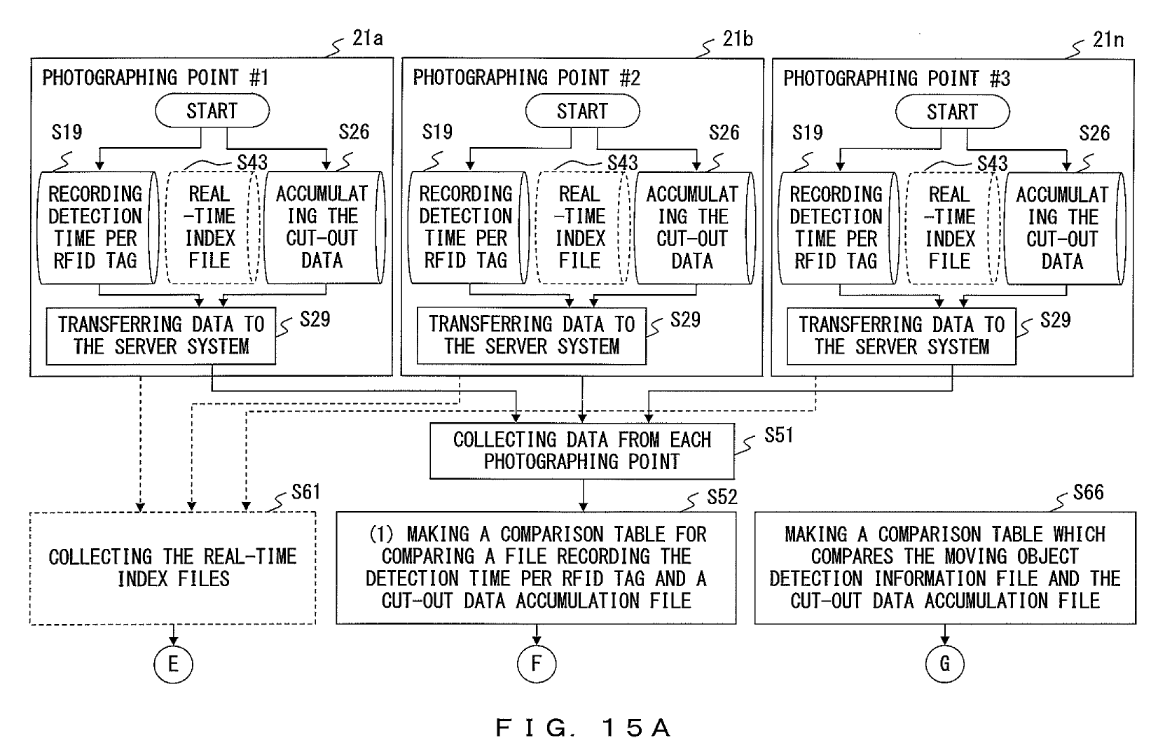

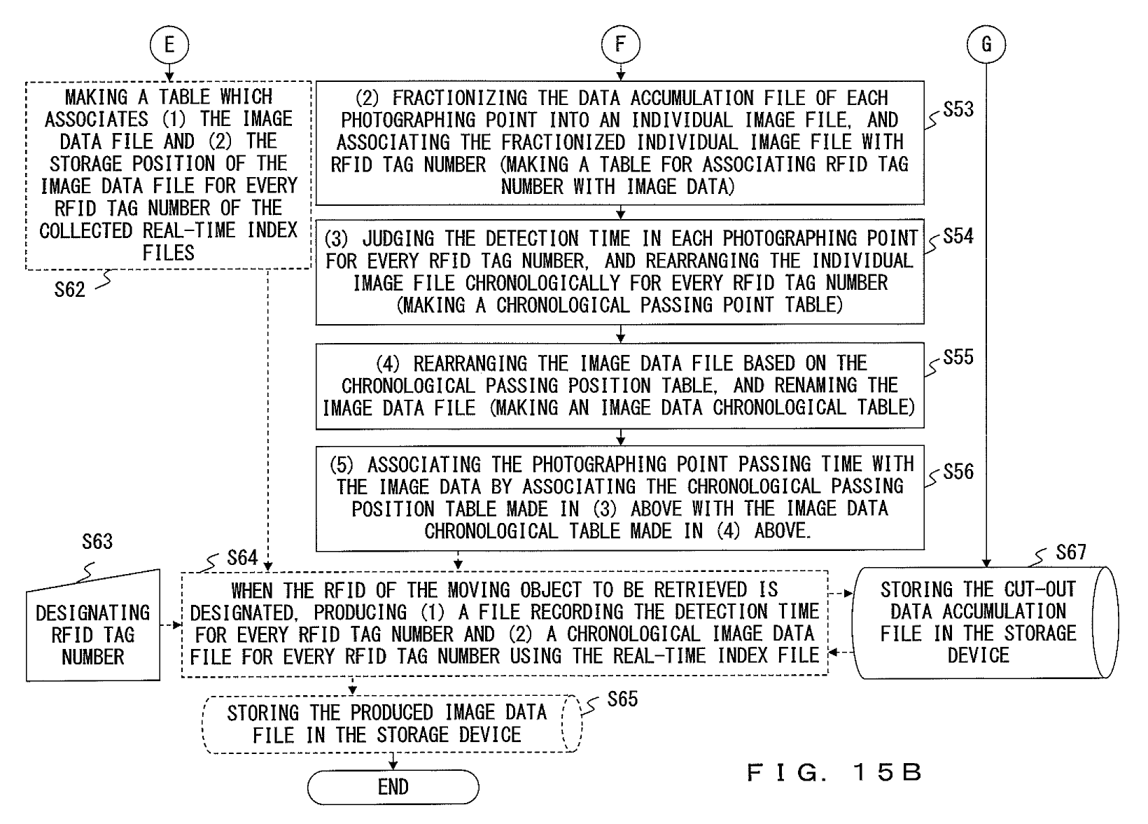

FIG. 15A and FIG. 15B are flowcharts showing the processing of the server system 31 in a second embodiment of the present invention. This second embodiment corresponds to the embodiment in which the real-time index file 43 is made and transmitted by each photography and detection apparatus 21a, 21b . . . 21n, and is the embodiment which adds the process of editing image data using the real-time index file 43 to the flowchart shown in FIG. 11B and FIG. 11B. In the following description, the same Step number is given to the same processing as in FIG. 11A and FIG. 11B.

The server system 31, when receiving the real-time index files 43 from each photography and detection apparatus 21a, 21b . . . 21n, collects those real-time index files 43 (S61 in FIG. 15).

Then, the server system 31 makes a table which acquires the image data file 42 and the storage position on the image data file 42 for every RFID tag number of the collected real-time index files 43 and associates the image data file 42 and the storage position on the image data file 42, namely a file which integrates the real-time index files of a plurality of photographing positions (S62).

In Step S66, the server system 31 makes a comparison table which compares the moving object detection information file (detection time record file) 41 recording the detection time for every RFID tag number of each photographing position and the cut-out data accumulation file, and stores the comparison table in the storage device of the server system 31 (S67).

When the RFID tag number of the moving object to be retrieved is designated (S63), the server system 31 produces the image data file 42 which chronologically rearranges the image data associated with the same RFID tag number based on the detection time of every RFID tag number and the integrated real-time index file (S64), and then, stores the produced imaged data file 42 in the storage device (S65).

According to the second embodiment, the real-time index file 43 is made by each photography and detection apparatus 21a, 21b . . . 21n, and the server system 31 makes the real-time index file 43 which integrates the real-time index files 43 of each photography and detection apparatus 21a, 21b . . . 21n for every RFID tag number. It is possible to acquire the image data of a moving object having the same RFID tag number photographed in a plurality of photographing positions based on the integrated real-time index file 43, and acquire the chronological image data of the moving object which is designated by rearranging the acquired image data chronologically.

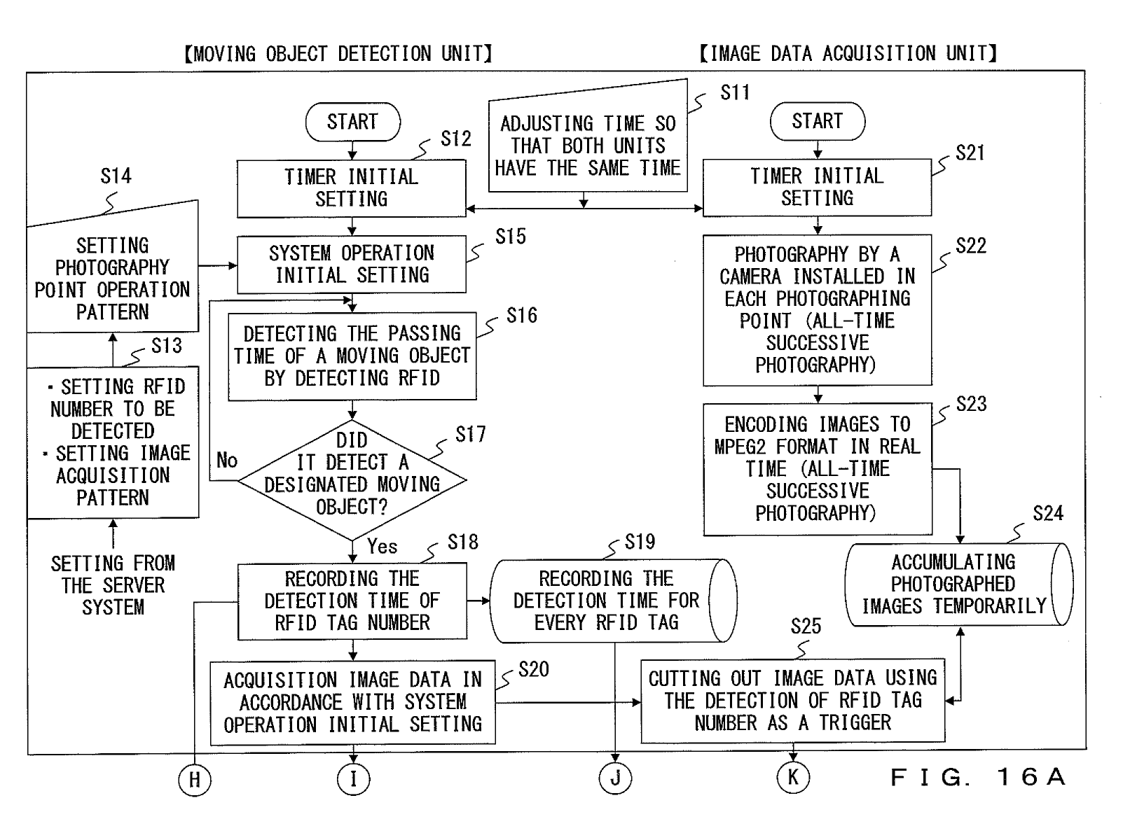

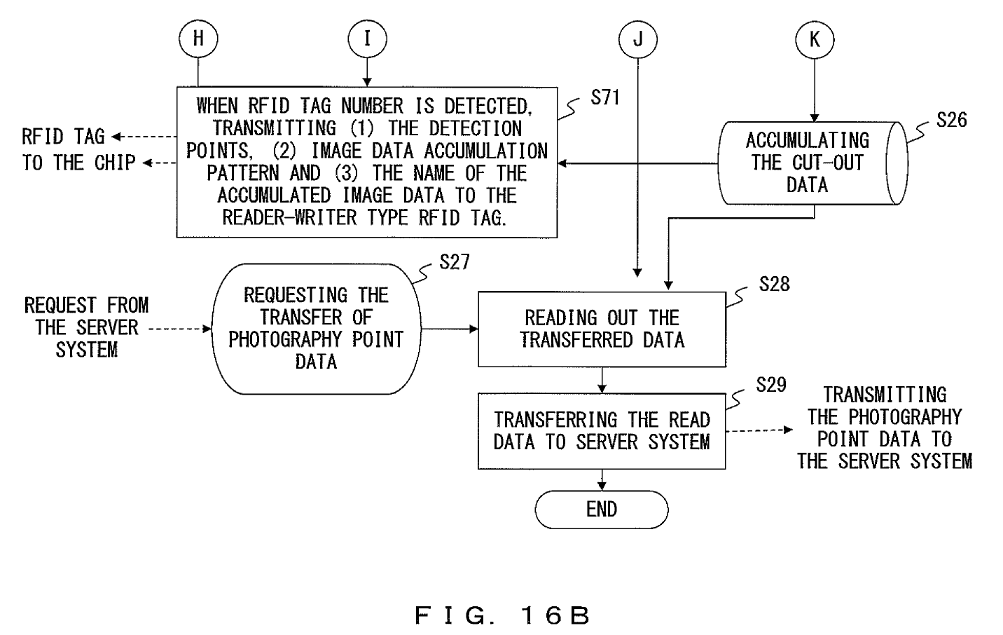

FIG. 16A and FIG. 16B are flowcharts showing the processing of the photography and detection apparatus in a third embodiment of the present invention.

This third embodiment is characterized in that when a RFID tag is detected, the RFID reader-writer 23 writes accumulated contents information in the RFID tag of a moving object.

In the following description, the same Step number is given to the same processing as in FIG. 3, FIG. 5 and FIG. 7A and FIG. 7B.

When the image data of the moving object of the designated RFID tag number is cut out based on the system operation initial setting value and said image data is stored in the storage device 25 (S26), the photography and detection apparatus 21 writes the accumulated contents information, for example, information concerning the photographing positions (detection points), the pattern of the acquired image data (pattern designated by an image data accumulation pattern), the name of the accumulated image data and so forth in the RFID tag of the moving object (S71 in FIG. 16B).

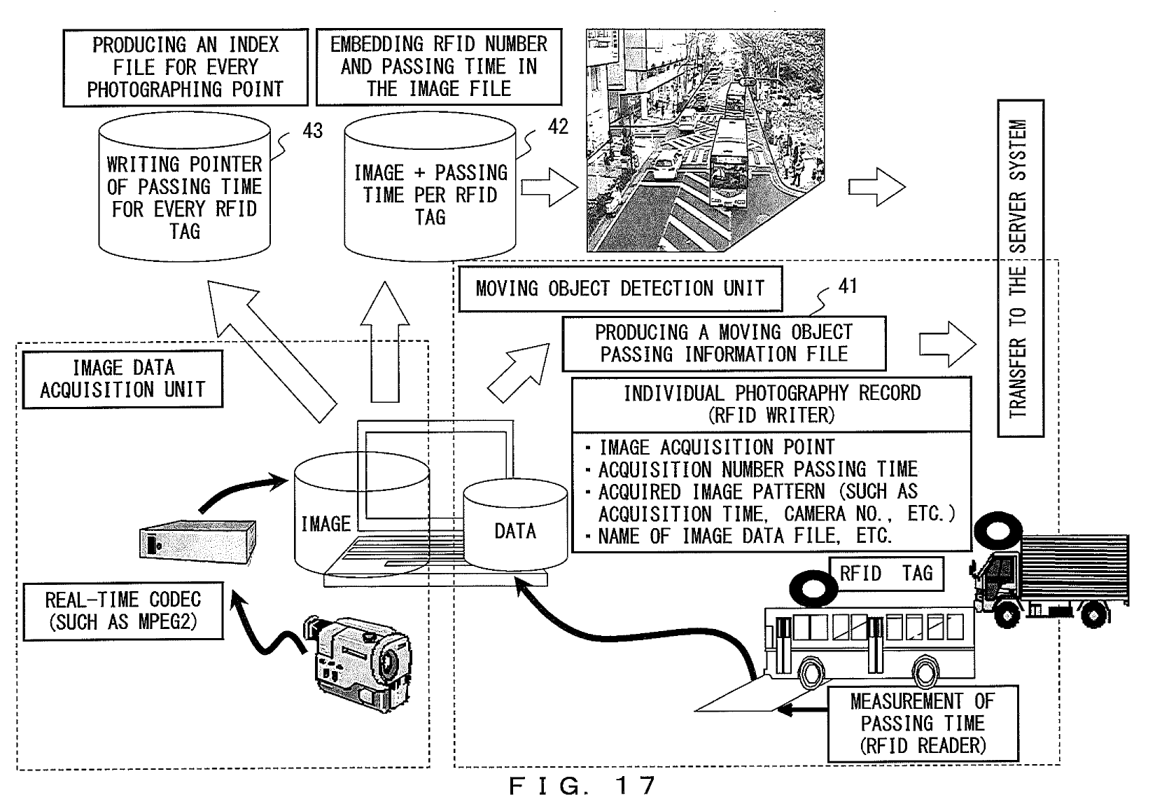

FIG. 17 shows the process of writing data to the RFID tag of a moving object. The RFID reader-writer 23, when detecting an RFID tag and recording the image data of a moving object, writes the data, acquisition number, passing time, acquired image pattern (such as the acquisition time and the camera), and image data file which indicate image acquisition positions to the RFID tag of the moving object.

Thus, the owner or manager of the RFID tag can retrieve and edit his data of images photographed based on the data recorded in the RFID tag and can use the data of the images even if he does not know the ID code of his RFID tag.

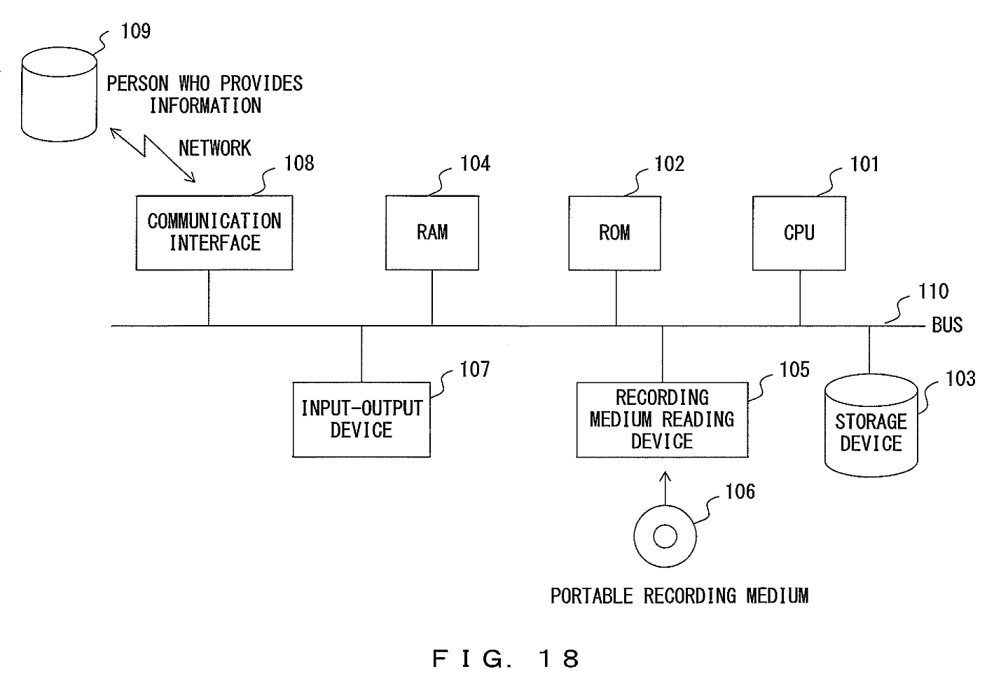

Described below is an example of the hardware configuration of the information processing system used as the photography and detection apparatus 21 and the server system 31 of the embodiment with reference to FIG. 18.

A CPU 101 acquires and stores image data based on the control program stored in a ROM 102.

The photography and detection program of the embodiment, the edition program and the data of images photographed by the camera are stored in an external storage device 103. A RAM 104 is used as various kinds of registers used for arithmetic calculation and as the region for storing data temporarily.

A recording medium reading device 105 reads or writes a portable recording medium 106 such as a CDROM, DVD, flexible disk and IC card. The image data retrieval program and edition program of the embodiment which are recorded in the portable recording medium 106 may be loaded to the external storage device 103.

An input device 107 is a device which inputs data such as a keyboard. A communication interface 108 is a device which connects the system to a network such as a LAN and the Internet, and can download data, a program, etc. from the server 109 of a person who provides information, etc. via the network. The CPU 101, RAM 104, external storage device 103, etc. are connected by a bus 110.

The present invention can be applied not only to the above embodiments but also to, for example, a physical distribution management system (the physical distribution management of a conveyer, a purchase analysis system of a convenience store, etc.), a traffic flow monitor system (for example, a system which monitors the movement of delivery cars such as a truck, bus, door-to-door delivery car, etc.), a system which confirms the location of a wandering aged person, a kindergarten-commuting and school-commuting management system, a system which records races and analyzes tactics in a sport scene, a system which provides commemorative images to visitors to amusement parks, etc. and so forth.

The medium or apparatus in which the moving object identification information for detecting a moving object is recorded is not limited to any particular medium or apparatus such as an IC card, not to mention an RFID tag.

The method of encoding image data is not limited to MPEG2, but any other publicly-known encoding method can apply.

According to the present invention, it is possible to retrieve the image data of a moving object having specific RFID from a vast amount of data of images photographed in a plurality of photographing positions. Thus, it is possible to extract image data of a specific moving object photographed in a plurality of photographing positions, collect the images to one image data file and confirm which path the moving object passes through.

What is claimed is:

1. An image file making method in which a server receiving a plurality of image data from outside the server, the server extracting image data of a specific photographed moving object from the plurality of image data received from outside the server and makes an image file, wherein
the server performs the steps of:
receiving from outside the server an identifier of an RFID of a moving object, a detection time of the RFID, and image data corresponding to the detection time;
mutually associating and storing in a storage unit the identifier of the RFID of the moving object, the detection time of the RFID, and the image data corresponding to the detection time;
extracting a plurality of image data associated with an identifier of a specific RFID from a plurality of image data stored in the storage unit; and
making an image file in which the plurality of extracted image data are chronologically arranged based on the detection time associated with each of the image data.

2. A server receiving a plurality of image data from outside the server, and extracting image data of a specific photographed moving object from the plurality of image data received from outside the server, and making an image file, the server comprising:
a storage unit receiving from outside the server an identifier of an RFID of a moving object, a detection time of the RFID, and image data corresponding to the detection time, the storage unit mutually associating and storing the identifier of the RFID of the moving object, the detection time of the RFID, and the image data corresponding to the detection time;
an extraction unit extracting a plurality of image data associated with an identifier of a specific RFID from a plurality of image data stored in the storage unit; and
a file making unit making an image file in which the plurality of extracted image data are chronologically arranged based on the detection time associated with each of the image data.

3. An image file making system in which a server receiving a plurality of image data photographed respectively by a photography apparatus arrayed in a plurality of positions, the server extracts image data of a specific photographed moving object from the plurality of received image data and makes an image file, wherein
the photography apparatus comprises:
a detection unit detecting an RFID of a moving object; and
a transmission unit transmitting to the server an identifier of the detected RFID, a detection time of the RFID, and image data corresponding to the detection time, and wherein
the server comprises:
a storage unit mutually associating and storing the identifier of the RFID, the detection time of the RFID, and the image data corresponding to the detection time, at least one of which is received from the photography apparatus;
an extraction unit extracting a plurality of image data associated with an identifier of a specific RFID from a plurality of image data stored in the storage unit; and
a file making unit making an image file in which the plurality of extracted image data are chronologically arranged based on the detection time associated with each of the image data.

4. A storage medium storing a program executable in a server that receives a plurality of image data from outside the server and extracts image data of a specific photographed moving object from the plurality of image data received from outside the server and makes an image file, wherein
the program causes the server to perform the processes of:
receiving from outside the server data including an identifier of an RFID of a moving object, a detection time of the RFID, and image data corresponding to the detection time;
mutually associating and storing the identifier of the RFID of the moving object, the detection time of the RFID, and the image data corresponding to the detection time;
extracting a plurality of image data associated with an identifier of a specific RFID from a plurality of image data stored in the storage unit; and making an image file in which the plurality of extracted image data are chronologically arranged based on the detection time associated with each of the image data.
